(19) United States
(12) Patent Application Publication
(10) Pub. No.: US 2006/0022465 A1
(43) Pub. Date: Feb. 2, 2006

(54) Pipe joint structure

(75) Inventor: Yoshihiro Yamauchi, Kanagawa (JP)

Correspondence Address: BAKER & BOTTS, 30 ROCKEFELLER PLAZA, NEW YORK, NY, 10112, US

(73) Assignee: KIORITZ CORPORATION, Tokyo (JP)

(21) Appl. No.: 11/192,462

(22) Filed: Jul. 26, 2005

(30) Foreign Application Priority Data
Jul. 28, 2004 (JP) 2004-219995

(51) Int. Cl. F16L 21/00

(52) U.S. Cl. 285/402

(57) ABSTRACT

There is provided a pipe joint structure wherein a proximal insert portion (20a) of an attachment pipe (20) is inserted into and secured to a base pipe (12). This pipe joint structure comprises: a cylindrical rotational operating member (30) rotatably and externally fitted on the base pipe; and a pin-shaped projection (25) which is radially protruded from the proximal insert portion of the attachment pipe; wherein the rotational operating member is provided, on an inner circumferential surface thereof, with a spiral pulling/pushing groove (35) enabling the pin-shaped projection to be introduced therein through a cut-out portion (16) formed at a distal portion (12a) of the base pipe, thereby enabling the attachment pipe to be pulled into the base pipe through the displacement of the pin-shaped projection along the groove as the rotational operating member is rotated in one direction and enabling the attachment pipe to be pushed out of the base pipe through the displacement of the pin-shaped projection along the groove as the rotational operating member is rotated in the opposite direction.

### FIELD

The present invention relates to a pipe joint structure which is suited for use in the connection between the air ejection port (base pipe) of blower and a blow off pipe (attachment pipe) in a portable air blowing working machine for example.

### BACKGROUND INFORMATION

An air blowing cleaner which is designed to perform cleaning by gathering fallen leaves and refuse, and a power sprayer which is designed to perform spraying of chemicals, etc., both utilizing an air flow (air blow) ejected from a centrifugal blower which can be rotationally driven by an internal combustion engine such as an air-cooled two-stroke internal combustion engine, are both conventionally known in the art.

FIG. 9 illustrates one example of the aforementioned portable air blowing cleaner. Referring to FIG. 9, the portable air blowing cleaner 100 shown therein is of a shoulder type and is designed to perform the working of gathering fallen leaves and refuse by making use of the ejection of accelerated and pressurized air instead of using a broom. This portable air blowing cleaner 100 is constructed such that it includes a shouldering frame 62 having a U-shaped configuration in plan view and provided with a couple of shouldering straps 64, a centrifugal type air blower 80 employed as an air blowing system and secured vertically through a vibration-proofing member (not shown) to the shouldering frame 62, and an air-cooled two-stroke internal combustion engine 60 for rotatably driving the air blower 80, the internal combustion engine 60 being directly coupled to the rear side of the centrifugal type air blower 80 and sustained by the shouldering frame 62.

The air blower 80 is constructed such that external air is drawn from the suction port thereof (not shown) and, after being accelerated and pressurized, is ejected from the air ejection port 85 thereof which is attached to one side of the air blower 80 and extended therefrom obliquely downward. To this air ejection port 85, there is connected a blow off pipe 90 which includes a bent pipe 91, a bellows-shaped flexible pipe 92, and a rigid ejection pipe 95. This ejection pipe 95 is provided, at a proximal end portion thereof, with a control handle 96 furnished with a lever for operating a carburetor throttle valve of the engine 20 as well as with switches 97.

In this portable air blowing cleaner 100, the blow off pipe 90 (bent pipe 91) is required to be connected to an attachment pipe with the air ejection port (base pipe) 85 of the air blower 80. Furthermore, all of the bent pipe 91, the bellows-shaped flexible pipe 92 and the rigid ejection pipe 95 constituting the blow off pipe 90 are required to be connected with each other.

Conventionally, the connection between the base pipe and the attachment pipe is generally conducted by inserting the base pipe into the attachment pipe since the diameter of the attachment pipe is larger than the diameter of the base pipe. As for the pipe joint structure in this case, there are known various structures such as a joint structure described in JP Patent No. 3519021 wherein the attachment pipe is externally fitted on the base pipe and then rotated relative to the base pipe, thereby fixedly connecting them with each other, or a joint structure using separately a clamping member or a fixture.

However, in the case of the conventional joint structure wherein the attachment pipe is fixed to the base pipe through the rotation of the joint structure, since the attachment pipe is relatively large in diameter, it is more or less difficult to hold the attachment pipe by one's hand, so that a large magnitude of force is required for fixedly connecting the attachment pipe with the base pipe. Further, there is a problem that when the attachment pipe is relatively large in length, it is difficult to perform this connecting operation.

In the joint structure where a clamping member or a fixture is employed, there is also a problem that the clamping member or the fixture may be often lost or failed to be attached to the joint portion.

The attachment pipe is usually manufactured by blow molding using a synthetic resin as a raw material. In this case, the dimensional accuracy of the inner diameter of the attachment pipe is likely to become poor (since outer diameter of pipe can be regulated according to the mold, the dimensional accuracy thereof can be easily secured). However, according to the conventional pipe joint structure, since the inner diameter of the attachment pipe which is likely to become poor in dimensional accuracy is employed for the engagement thereof with the base pipe (external fitting on the base pipe), it has been difficult to reliably and firmly fix the attachment pipe to the base pipe, resulting in the connection which is low in stability and reliability.

Moreover, in recent years, there is an increasing trend to enforce the safety regulation demanding the employment of a tool for the disconnection of the attachment pipe (i.e. unless there is an intentional operation using tool, it is impossible to disengage the attachment pipe from the base pipe). Therefore, it is desirable to now develop a structure that more easily complies with such a safety regulation. It may be conceivable, as the solution, to employ screws for the connection of the attachment pipe to the base pipe. However, even in that case, there may be many possibilities that the screws will be lost or failed to be attached to the joint portion. Additionally, the operation of fastening or loosening the screws every time when the attachment pipe is mounted or dismounted is bothersome.

### BRIEF SUMMARY OF THE INVENTION

The present invention has been made in view of the aforementioned problems, and therefore one of the objects of the present invention is to provide a pipe joint structure which makes it possible to easily, reliably and firmly connect the attachment pipe to the base pipe without necessitating the employment of a clamping member or a fixture, thereby making it possible to enhance the safety and reliability of the joint portion and to cope with the safety regulation without necessitating troublesome operations.

With a view to realize the aforementioned object, the present invention provides a pipe joint structure which is designed to enable a proximal insert portion of attachment pipe to be inserted in and secured (e.g. cannot be removed without being intentionally detached) to a base pipe. The pipe joint structure includes a cylindrical rotational operating member which is rotatably and externally fitted on the base pipe, and a pin-shaped projection which is radially protruded from the proximal insert portion of the attachment pipe, wherein the rotational operating member is provided, on an inner circumferential surface thereof, with a spiral pulling/pushing groove which is configured to enable the pin-shaped projection to be introduced therein through a cut-out portion formed at a distal portion of the base pipe, thereby enabling the attachment pipe to be pulled into the base pipe through the displacement of the pin-shaped projection along the pulling/pushing groove as the rotational operating member is rotated in one direction and enabling the attachment pipe to be pushed out of the base pipe through the displacement of the pin-shaped projection along the pulling/pushing groove as the rotational operating member is rotated in the opposite direction.

In an exemplary embodiment, the pipe joint structure is constructed such that the proximal insert portion of attachment pipe can be inserted into the base pipe until the pin-shaped projection is displaced to reach a starting end portion of the pulling/pushing groove, that when the rotational operating member is rotated in one direction, the pin-shaped projection is pushed by a fore-wall of the pulling/pushing groove, thereby enabling the attachment pipe to be pulled into the base pipe to secure the proximal insert portion of attachment pipe to the base pipe, and that when the rotational operating member is rotated in the opposite direction in the state where the proximal insert portion of attachment pipe is secured to the base pipe, the pin-shaped projection is pushed by a rear-wall of the pulling/pushing groove, thereby enabling the attachment pipe to be pushed out of the base pipe.

In another exemplary embodiment, the base pipe as well as the rotational operating member are respectively provided with a longitudinal movement-limiting means for restricting the movement in the axial direction of the rotational operating member and for preventing the rotational operating member from being inadvertently disengaged from the base pipe.

In a further exemplary embodiment, the base pipe as well as the rotational operating member are respectively provided with a rotation-limiting means for restricting the range of rotation of the rotational operating member.

In a further exemplary embodiment, the base pipe as well as the rotational operating member are respectively provided with a locking mechanism for preventing the disengagement of the attachment pipe from the base pipe unless the disengagement of the attachment pipe is intentionally performed.

This locking mechanism may be formed of a structure including a locking projection projected radially inward from the inner circumferential surface of the rotational operating member, an aperture which is formed in the base pipe and part of the aperture being permitted to expose from the rotational operating member without being covered by the rotational operating member, and a lock lever integrally attached, through a proximal end thereof, to the base pipe, elastically and flexibly extending along the interior of the aperture, and provided with a locking portion which is configured to engage with the locking projection so as to lock the rotational operating member on the occasion when the rotational operating member is rotated in said one direction at a predetermined angle. In this locking mechanism, the locked state of the rotational operating member can be released by inserting a tool into said part of the aperture which is exposed from the rotational operating member without being covered by the rotational operating member and by pushing the locking lever inward by making use of the tool.

As for the attachment pipe, it can be manufactured by blow molding using a synthetic resin as a material.

According to the pipe joint structure of the present invention, since the attachment pipe can be secured to the base pipe by inserting the proximal insert portion of the attachment pipe into the base pipe and, at the same time, since the attachment of the attachment pipe to the base pipe is effected through the employment of the outer diameter of the attachment pipe (i.e. insertion of the attachment pipe into the base pipe) which can be finished with high dimensional precision, it is now possible to reliably and firmly attach the attachment pipe to the base pipe, thereby making it possible to enhance the safety and reliability of the joint portion.

Furthermore, since the rotational operating member which is adapted to be rotatably attached to the base pipe is employed for the connection of the attachment pipe to the base pipe instead of the clamping member or the fixture which has been conventionally employed, it is now possible not only to obviate any possibilities of losing the clamping member or the fixture or possibilities of failing to attach them to the joint portion, but also to perform the connecting operation of the attachment pipe more easily.

Moreover, since the locking mechanism provided with a locking lever and other components is employed instead of screws, it is now possible to sufficiently cope with the aforementioned safety regulation without necessitating any bothersome operation.

### BRIEF DESCRIPTION OF THE DRAWINGS

FIG. 1 is an enlarged exploded perspective view illustrating one embodiment of the pipe joint structure according to the present invention;

FIG. 2 is a perspective view illustrating a state wherein a rotational operating member is attached to the base pipe utilizing the pipe joint structure of FIG. 1;

FIG. 3 is a perspective view illustrating a state wherein an attachment pipe is attached to the base pipe utilizing the pipe joint structure of FIG. 1;

FIG. 4 is a side view taken illustrating a region around the air ejection port of fan case constituting a base pipe utilizing the pipe joint structure of FIG. 1;

FIG. 5 is a cross-sectional view taken along the line V-V of FIG. 4;

FIG. 6 is a side view illustrating the internal structure of a half body constituting the rotational operating member utilizing the pipe joint structure of FIG. 1;

FIG. 7 is a plan view of the half body shown in FIG. 6;

FIGS. 8(A) and 8(B) are cross-sectional views each illustrating the locking mechanism of the rotational operating member a plan view utilizing the pipe joint structure of FIG. 1; and

FIG. 9 is a perspective view illustrating a manner of using the conventional portable air blast cleaner.

### DETAILED DESCRIPTION

The specific embodiments of the pipe joint structure according to the present invention will be explained in detail with reference to drawings.

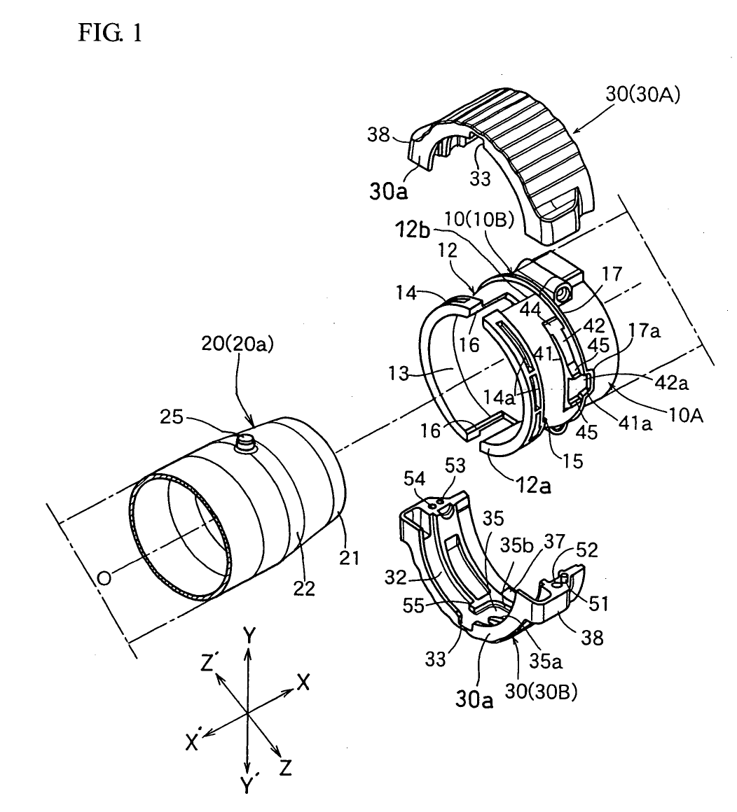

FIG. 1 illustrates one embodiment of the pipe joint structure according to the present invention.

The pipe joint structure shown therein is adapted to be employed in the connection between the air ejection port (base pipe) of blower (fan case) and a blow off pipe (attachment pipe) in the aforementioned air blowing cleaner, and is constructed such that a proximal insert portion of the attachment pipe is inserted into the base pipe so as to secure the attachment pipe to the base pipe.

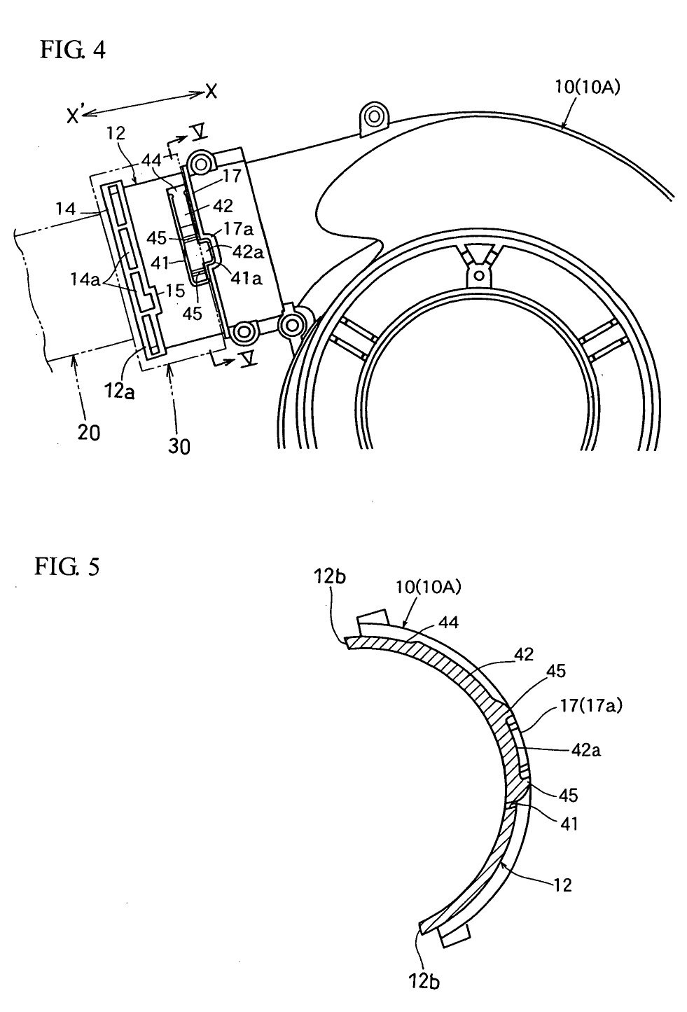

Namely, as seen from FIG. 4 together with FIG. 1, on one side of the fan case 10 of a two-piece structure comprising of a right half body 10A and a left half body 10B which are joined together through a mating face 12b by screw bolts, is a base pipe 12 constituting an air injection port, which is projected therefrom extending obliquely downward. The base pipe 12 is configured such that a proximal insert portion 20a of the attachment pipe 20 constituting the blow off pipe is enabled to be insert therein and secured thereto. In order to enable the attachment pipe 20 to be secured to the base pipe 12, the pipe joint structure is provided with a cylindrical rotational operating member 30 which is adapted to be rotatably and externally fitted on the base pipe 12.

The inner circumferential surface 13 of the base pipe 12 is tapered, resulting in a gradual decrease of the inner diameter of the base pipe in the depth-wise direction (in the direction of X). The attachment pipe 20 is generally manufactured by blow molding using a synthetic resin as a raw material. In order to ensure the firm engagement between the attachment pipe 20 and the base pipe 12 and to prevent the leakage of air, the proximal insert portion 20a of the attachment pipe 20 is provided, at a distal end portion as well as at an intermediate portion thereof, with a distal tapered portion 21 and an intermediate tapered portion 22, both having respectively a maximum outer diameter which is larger than a minimum inner diameter of the corresponding portions of the inner circumferential surface 13 of the base pipe 12. At the same time, the attachment pipe 20 is integrally provided with a couple of pin-shaped projections 25 which are protruded radially outward (in the directions of Y and Y′) and spaced away each other in the circumferential direction by an angle of 180°.

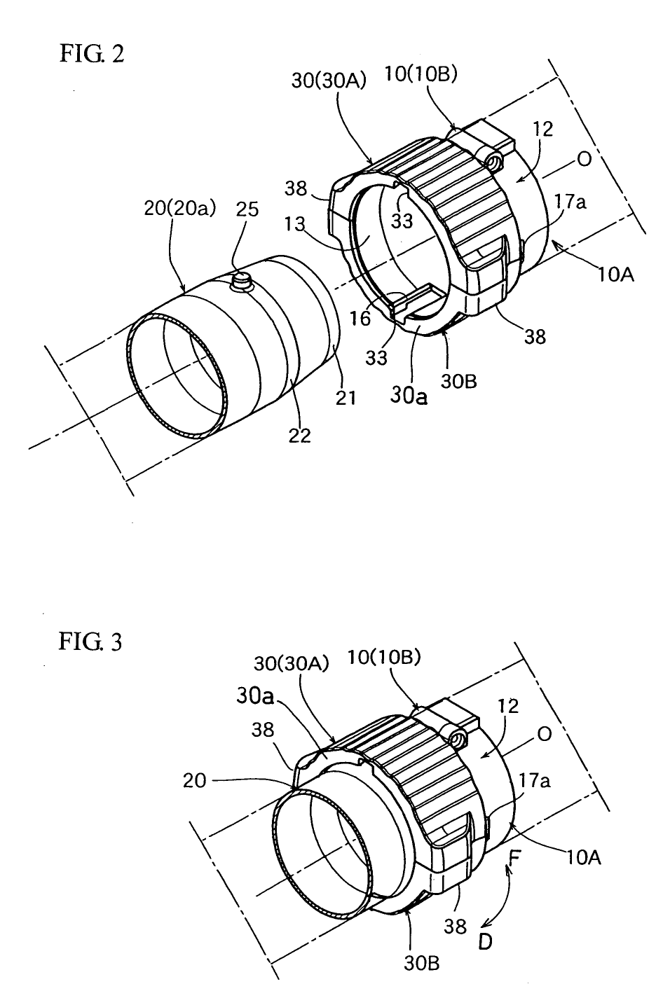

As shown in FIGS. 2, 3, and 6, the rotational operating member 30 is constituted by a couple of half bodies 30A and 30B having the same configuration with each other (these bodies are connected together with the inner surfaces thereof being aligned to face each other and fastened using screws) and manufactured by injection molding. This rotational operating member 30 is provided, successively from the distal end (X′ side) to the proximal end (X side) thereof, with an annular movement-restricting groove 32 acting as a movement restricting means for restricting the movement of the rotational operating member 30 in the axial direction “O” thereof (X′-X direction) and for preventing the rotational operating member 30 from coming out of the base pipe 12, a tapered spiral pulling/pushing groove 35 which is configured to enable the pin-shaped projection 25 to be introduced therein through a cut-out portion 16 formed extending a predetermined distance from a distal portion of the base pipe and along the axial direction “O” of the base pipe 12, thereby enabling the attachment pipe 20 to be pulled into the base pipe 12 (in the direction of X) and also enabling the attachment pipe 20 to be pushed out of the base pipe 12 (in the direction of X′), and with a couple of locking projections 37 projected inward from the inner circumferential surface of a proximal end portion of the rotational operating member 30 and spaced apart from each other by an angle of 180°, the locking projections 37 constituting a portion of the locking mechanism for preventing the disengagement of the attachment pipe from the base pipe unless the disengagement of the attachment pipe is intentionally performed by making use of a tool. This rotational operating member 30 is further provided with a couple of inlets 33 formed at an inward flange 30a constituting a front side of the annular movement-restricting groove 32.

In order to facilitate the formation of the cut-out portion 16 by molding, it would be more convenient to make the mating face 12 coincide with one side of the cut-out portion 16.

Further, the rotational operating member 30 is provided, on the outer circumferential surface thereof, with a corrugated portion in order to facilitate the rotational operation of the rotational operating member 30, and with a couple of right and left protrusions 38 which are radially protruded for facilitating the interconnection of the half bodies 30A and 30B. One of these protrusions 38 is provided with a pin 51 which is projected along the axial direction “O” and with a simple hole 52. The other of these protrusions 38 is provided with a pin hole 53 configured to be engaged with the pin 51 and with a screw hole 54 into which a connecting screw is screwed via the simple hole 52. These protrusions 38 can be also utilized as a finger stopper on the occasion of turning the rotational operating member 30.

The base pipe 12 is provided, on the outer circumferential surface of the fore-end portion 12a thereof, with a movement-restricting flange portion 14 having an enlarged diameter and a wide width, which is adapted to be loosely fitted in the movement-restricting groove 32 and is configured not only to restrict the movement of the rotational operating member 30 in the axial direction “O” thereof (in the direction of X′-X) but also to act as a movement-restricting means so as to prevent the rotational operating member 30 from coming out of the base pipe 12. This movement-restricting flange portion 14 is provided, along the circumferential surface thereof, with a plurality of lightening grooves 14a and, at the same time, this movement-restricting flange portion 14 is provided, as a rotation restricting means for restricting the range of the rotation of rotational operating member 30, with a stopper portion 15 which is adapted to be contacted and engaged with a movement-stopping portion 55 which is positioned close to the inlet 33 of the movement-restricting groove 32 and extended in a direction to narrow the width of the movement-restricting groove 32. This stopper portion 15 is projected inward in axial direction (i.e. in the direction of X).

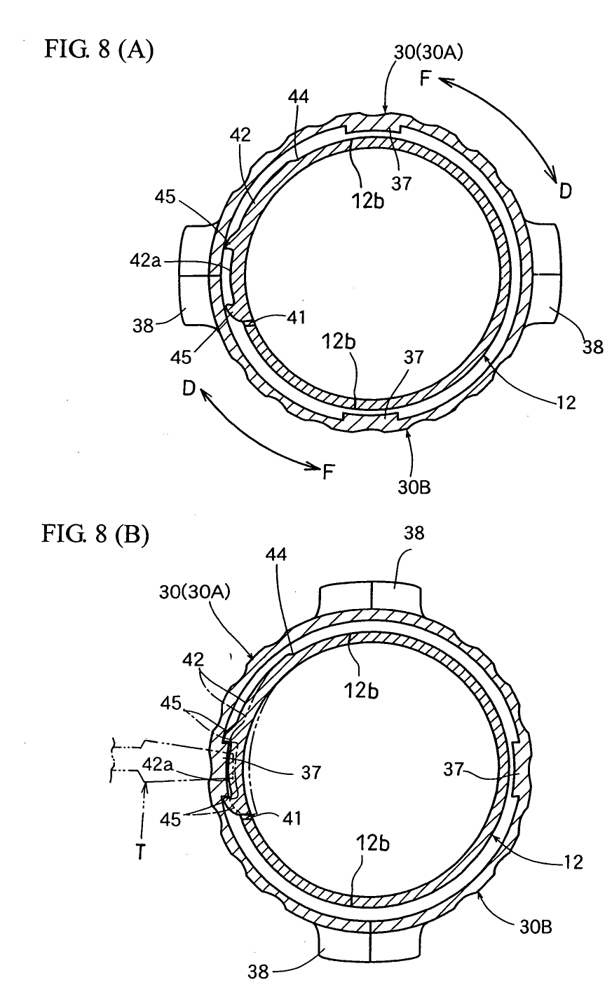

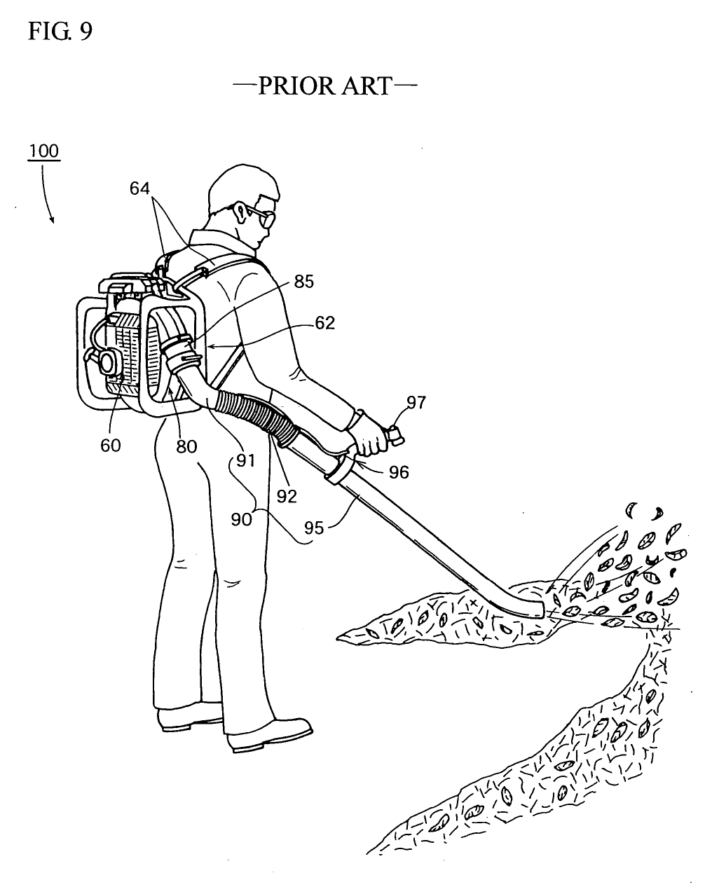

The left half body 10A of the base pipe 12 is provided with a locking mechanism which makes it possible to prevent the disengagement of the attachment pipe 20 from the base pipe 12 unless the disengagement of the attachment pipe is intentionally performed by making use of a tool such as a minus screwdriver. This locking mechanism is formed of a structure including a locking projection 37 projected radially inward from the inner circumferential surface of the rotational operating member 30, an aperture 41 of elongated configuration which is formed in the base pipe 12 and along a collar portion 17 formed on a central portion of the circumferential surface of the base pipe 12 and having a projected portion 17a extending inward (in the direction of X) so as to prevent the insertion of one's finger, part (a wide portion 41a extending inward (in the direction of X)) of the aperture 41 being exposed from the rotational operating member 30 so as not to be covered by the rotational operating member 30, and a lock lever 42 integrally attached, through a proximal end 44 thereof, to the base pipe 12, elastically and flexibly extending along the interior of the aperture 41 as indicated by a two-dot chain line in FIG. 8(B), and provided with a couple of locking portions 45 which is configured to engage with the locking projection 37 which is designed to be locked between the locking portions 45 so as to lock the rotational operating member 30 on the occasion when the rotational operating member 30 is rotated in one direction “F” at an angle of about 90° (see FIGS. 1, 4 and 5). In this locking mechanism, the locked state of the rotational operating member 30 can be released by inserting a tool “T” (a minus screwdriver or plug wrench) into the part (wide portion 41 a) of the aperture 41 which is slightly exposed from the rotational operating member 30 so as not to be covered by the rotational operating member 30 and by pushing the distal wide portion 42a of locking lever 42 inward by making use of the tool.

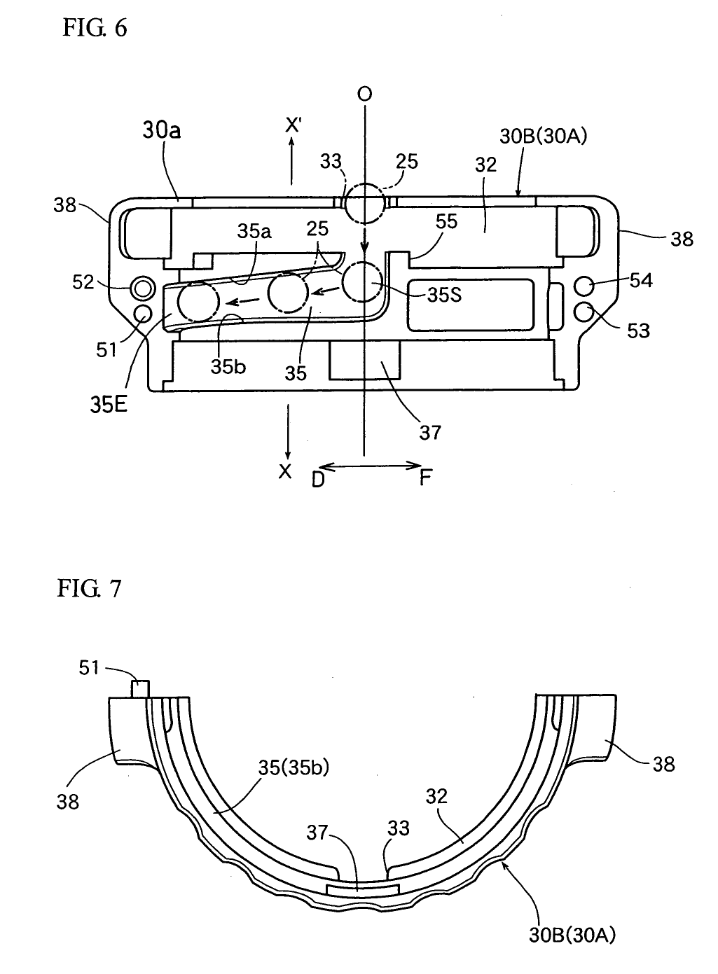

In the pipe joint structure according to this embodiment which is constructed as described above, if it is desired to connect and secure the attachment pipe 20 to the base pipe 12 by inserting the proximal insert portion 20a of the attachment pipe 20, the inlets 33 of the attachment pipe 30 are aligned at first with the cut-out portions 16 of the base pipe 12 and then the proximal insert portion 20a of the attachment pipe 20 is inserted into the base pipe 12 until the pin-shaped projections 25 reach the starting end portion 35S of the pulling/pushing groove 35 (see FIG. 6)(the state shown in FIG. 3). Thereafter, the rotational operating member 30 is rotated in one direction “F” by an angle of about 90°, thereby enabling the pin-shaped projections 25 to be pushed inward (in the direction of X) by the fore-wall 35a of the pulling/pushing grooves 35, thus enabling the attachment pipe 20 to be pulled inward (in the direction of X). As a result, the proximal insert portion 20a (the tapered distal end portion 21 and the tapered intermediate portion 22) of the attachment pipe 20 is press-contacted with and firmly fixed to the base pipe 12 and, at the same time, the pin-shaped projections 25 can be firmly held by the tapered distal end portions 35E of the pulling/pushing grooves 35. When the attachment pipe 30 is rotated in the opposite direction under the aforementioned condition, the pin-shaped projections 25 are pushed by the rear-wall 35b of the pulling/pushing grooves 35, thereby enabling the attachment pipe 20 to be pushed in the direction to disconnect it from the base pipe 12 (however, it is necessary to release in advance the locked state of the rotational operating member 30).

When the rotational operating member 30 is rotated in one direction “F” by an angle of about 90°, the movement-stopping portion 55 provided in the movement-restricting groove 32 of the rotational operating member 30 is caused to contact and engage with the stopper portion 15 formed on the outer circumferential surface of the base pipe 12, thereby stopping the rotation of the rotational operating member 30 and at the same time, the cut-out portion 16 of the base pipe 12 is covered by the front face portion 30a of the rotational operating member 30, thereby making it possible to prevent problems such as the failure of actuation of the apparatus due to the contamination of the interior of the apparatus with refuse.

Further, as shown in FIGS. 8(A) and 8(B), on the occasion of rotating the rotational operating member 30 in one direction “F” by an angle of about 90°, the locking projections 37 formed in the rotational operating member 30 is caused to ride over the locking lever 42 (the locking portions 45 located on the proximal end 44 side) and to push it downward (as shown by the two-dot chain line indicated in FIG. 8(B), the locking lever 42 is caused to elastically bend). When the rotational operating member 30 is further rotated (when the locking projections 37 is permitted to run over the locking portions 45 located on the proximal end 44 side), the locking projections 37 is caused to drop between a couple of the locking portions 45 and lock. As a result, the rotational operating member 30 is locked, so that the attachment pipe 20 cannot be removed from the base pipe 12 unless the disengagement of the attachment pipe 20 is intentionally performed by making use of a tool.

As described above, according to the pipe joint structure of this embodiment, since the attachment pipe 20 can be secured to the base pipe 12 by inserting the proximal insert portion 20a of the attachment pipe 20 into the base pipe 12 and, at the same time, since the attachment of the attachment pipe 20 to the base pipe 12 is effected through the employment of the outer diameter of the attachment pipe 20 (i.e. insertion of the attachment pipe 20 into the base pipe 12) which can be finished with high dimensional precision, it is now possible to reliably and firmly attach the attachment pipe 20 to the base pipe 12, thereby making it possible to enhance the safety and reliability of the joint portion.

Further, since the rotational operating member 30 which is adapted to be rotatably attached to the base pipe 12 is employed for the connection of the attachment pipe 20 to the base pipe 12 instead of the clamping member or the fixture which has been conventionally employed, it is now possible not only to obviate any possibilities of losing the clamping member or the fixture or possibilities of failing to attach them to the joint portion, but also to perform the connecting operation of the attachment pipe 20 more easily.

Moreover, since the locking mechanism provided with a locking lever 42 and other components is employed instead of screws, it is now possible to sufficiently cope with the aforementioned safety regulation without necessitating any bothersome operation.

What is claimed is:

1. A pipe joint structure configured to enable a proximal insert portion of an attachment pipe to be inserted in and secured to a base pipe, the pipe joint structure comprising:
a cylindrical rotational operating member which is rotatably and externally fitted on the base pipe, the rotational operating member including, on an inner circumferential surface thereof, a spiral pulling/pushing groove; and
a pin-shaped projection which is radially protruded from the proximal insert portion of the attachment pipe;
wherein the groove is configured to enable the pin-shaped projection to be introduced therein through a cut-out portion formed at a distal portion of the base pipe, thereby enabling the attachment pipe to be pulled into the base pipe through the displacement of the pin-shaped projection along the pulling/pushing groove as the rotational operating member is rotated in one direction and enabling the attachment pipe to be pushed out of the base pipe through the displacement of the pin-shaped projection along the pulling/pushing groove as the rotational operating member is rotated in the opposite direction.

2. The pipe joint structure according to claim 1, wherein the proximal insert portion of the attachment pipe is insertable into the base pipe until the pin-shaped projection is displaced to reach a starting end portion of the pulling/pushing groove, that when the rotational operating member is rotated in said one direction, the pin-shaped projection is pushed by a fore-wall of the pulling/pushing groove, thereby enabling the attachment pipe to be pulled into the base pipe to secure the proximal insert portion of the attachment pipe to the base pipe, and that when the rotational operating member is rotated in the opposite direction when the proximal insert portion of the attachment pipe is secured to the base pipe, the pin-shaped projection is pushed by a rear-wall of the pulling/pushing groove, thereby enabling the attachment pipe to be pushed out of the base pipe.

3. The pipe joint structure according to claim 1, wherein the base pipe and the rotational operating member further comprise a longitudinal movement-limiting portion for restricting the movement in the axial direction of the rotational operating member and for preventing the rotational operating member from being inadvertently disengaged from the base pipe.

4. The pipe joint structure according to claim 1, wherein the base pipe and the rotational operating member further comprise a rotation-limiting portion for restricting the range of rotation of the rotational operating member.

5. The pipe joint structure according to claim 1, wherein the base pipe and the rotational operating member further comprise a locking mechanism for preventing the unintentional disengagement of the attachment pipe from the base pipe.

6. The pipe joint structure according to claim 5, wherein the locking mechanism comprises:
a locking projection projected radially inward from the inner circumferential surface of the rotational operating member,
an aperture which is formed in the base pipe, at least part of the aperture not being covered by the rotational operating member, and
a lock lever integrally attached, through a proximal end thereof, to the base pipe, elastically and flexibly extending along the interior of the aperture, and provided with a locking portion which is configured to engage with the locking projection so as to lock the rotational operating member when the rotational operating member is rotated in said one direction at a predetermined angle,
wherein inserting a tool into said part of the aperture which is exposed from the rotational operating member without being covered by the rotational operating member and pushing the locking lever inward with the tool will release the rotational operating member from a locked state.

7. The pipe joint structure according to claim 1, wherein the attachment pipe is manufactured by blow molding using a synthetic resin as a material.

8. A pipe joint structure configured to enable a proximal insert portion of an attachment pipe to be inserted in and secured to a base pipe, the pipe joint structure comprising:
a rotational operating member which is rotatably and externally fitted on the base pipe, the rotational operating member including, on an inner circumferential surface thereof, a pulling/pushing groove; and
a projection which is radially protruded from the proximal insert portion of the attachment pipe;
wherein the groove is configured to enable the projection to be introduced therein through a cut-out portion formed at a distal portion of the base pipe, thereby enabling the attachment pipe to be pulled into the base pipe through the displacement of the projection along the pulling/pushing groove as the rotational operating member is rotated in one direction and enabling the attachment pipe to be pushed out of the base pipe through the displacement of the projection along the pulling/pushing groove as the rotational operating member is rotated in the opposite direction.

9. The pipe joint structure according to claim 8, wherein the proximal insert portion of the attachment pipe is insertable into the base pipe until the projection is displaced to reach a starting end portion of the pulling/pushing groove, that when the rotational operating member is rotated in said one direction, the projection is pushed by a fore-wall of the pulling/pushing groove, thereby enabling the attachment pipe to be pulled into the base pipe to secure the proximal insert portion of the attachment pipe to the base pipe, and that when the rotational operating member is rotated in the opposite direction when the proximal insert portion of the attachment pipe is secured to the base pipe, the projection is pushed by a rear-wall of the pulling/pushing groove, thereby enabling the attachment pipe to be pushed out of the base pipe.

10. The pipe joint structure according to claim 8, wherein the base pipe and the rotational operating member further comprise a longitudinal movement-limiting portion for restricting the movement in the axial direction of the rotational operating member and for preventing the rotational operating member from being inadvertently disengaged from the base pipe.

11. The pipe joint structure according to claim 8, wherein the base pipe and the rotational operating member further comprise a rotation-limiting portion for restricting the range of rotation of the rotational operating member.

12. The pipe joint structure according to claim 8, wherein the base pipe and the rotational operating member further comprise a locking mechanism for preventing the unintentional disengagement of the attachment pipe.

13. The pipe joint structure according to claim 12, wherein the locking mechanism comprises:
a locking projection projected radially inward from the inner circumferential surface of the rotational operating member,
an aperture which is formed in the base pipe, at least part of the aperture not being covered by the rotational operating member, and
a lock lever integrally attached, through a proximal end thereof, to the base pipe, elastically and flexibly extending along the interior of the aperture, and provided with a locking portion which is configured to engage with the locking projection so as to lock the rotational operating member when the rotational operating member is rotated in said one direction at a predetermined angle,
wherein inserting a tool into said part of the aperture which is exposed from the rotational operating member without being covered by the rotational operating member and pushing the locking lever inward with the tool will release the rotational operating member from a locked state.

14. The pipe joint structure according to claim 8, wherein the attachment pipe is manufactured by blow molding using a synthetic resin as a material.

15. A pipe joint structure configured to enable a proximal insert portion of an attachment pipe to be inserted in and attached to a base pipe, the pipe joint structure comprising:
a cylindrical rotational operating member which is rotatably and externally fitted on the base pipe, the rotational operating member including, on an inner circumferential surface thereof, a spiral pulling/pushing groove; and
a pin-shaped projection which is radially protruded from the proximal insert portion of the attachment pipe;
wherein the groove is configured to enable the pin-shaped projection to be introduced therein through a cut-out portion formed at a distal portion of the base pipe, thereby enabling the attachment pipe to be pulled into the base pipe through the displacement of the pin-shaped projection along the pulling/pushing groove as the rotational operating member is rotated in one direction and enabling the attachment pipe to be pushed out of the base pipe through the displacement of the pin-shaped projection along the pulling/pushing groove as the rotational operating member is rotated in the opposite direction.

16. The pipe joint structure according to claim 15, wherein the proximal insert portion of the attachment pipe is insertable into the base pipe until the pin-shaped projection is displaced to reach a starting end portion of the pulling/pushing groove, that when the rotational operating member is rotated in said one direction, the pin-shaped projection is pushed by a fore-wall of the pulling/pushing groove, thereby enabling the attachment pipe to be pulled into the base pipe to attach the proximal insert portion of the attachment pipe to the base pipe, and that when the rotational operating member is rotated in the opposite direction when the proximal insert portion of the attachment pipe is attached to the base pipe, the pin-shaped projection is pushed by a rear-wall wall of the pulling/pushing groove, thereby enabling the attachment pipe to be pushed out of the base pipe.

17. The pipe joint structure according to claim 15, wherein the base pipe and the rotational operating member further comprise a longitudinal movement-limiting portion for restricting the movement in the axial direction of the rotational operating member and for preventing the rotational operating member from being inadvertently disengaged from the base pipe.

18. The pipe joint structure according to claim 15, wherein the base pipe and the rotational operating member further comprise a rotation-limiting portion for restricting the range of rotation of the rotational operating member.

19. The pipe joint structure according to claim 15, wherein the base pipe and the rotational operating member further comprise a locking mechanism for preventing the unintentional disengagement of the attachment pipe from the base pipe.

20. The pipe joint structure according to claim 19, wherein the locking mechanism comprises:
a locking projection projected radially inward from the inner circumferential surface of the rotational operating member,
an aperture which is formed in the base pipe, at least part of the aperture not being covered by the rotational operating member, and
a lock lever integrally attached, through a proximal end thereof, to the base pipe, elastically and flexibly extending along the interior of the aperture, and provided with a locking portion which is configured to engage with the locking projection so as to lock the rotational operating member when the rotational operating member is rotated in said one direction at a predetermined angle,
wherein inserting a tool into said part of the aperture which is exposed from the rotational operating member without being covered by the rotational operating member and pushing the locking lever inward with the tool will release the rotational operating member from a locked state.

21. The pipe joint structure according to claim 15, wherein the attachment pipe is manufactured by blow molding using a synthetic resin as a material.
